(19) United States
(12) Patent Application Publication
(10) Pub. No.: US 2008/0069746 A1
(43) Pub. Date: Mar. 20, 2008

(54) METHOD AND APPARATUS FOR MICROWAVE INDUCED PYROLYSIS OF ARSENICAL ORES AND ORE CONCENTRATES

(75) Inventor: James Tranquilla, New Brunswick (CA)

Correspondence Address: SHERIDAN ROSS PC, 1560 BROADWAY, SUITE 1200, DENVER, CO, 80202, US

(73) Assignee: HW ADVANCED TECHNOLOGIES, INC., Lakewood, CO (US)

(21) Appl. No.: 11/858,460

(22) Filed: Sep. 20, 2007

Related U.S. Application Data
(60) Provisional application No. 60/826,344, filed on Sep. 20, 2006.
(60) Provisional application No. 60/887,085, filed on Jan. 29, 2007.

(51) Int. Cl. C01G 28/00

(52) U.S. Cl. 423/88

(57) ABSTRACT

A method is provided that includes the steps of passing microwave energy through a sulfidic material comprising arsenopyrite and pyrite to reduce at least most of the arsenopyrite to arsenic sulfide and form a calcine, the material being positioned in a reaction chamber of a reactor vessel and removing the arsenic sulfide from the calcine.

### CROSS REFERENCE TO RELATED APPLICATION

The present application claims the benefits of U.S. Provisional Application Ser. No. 60/826,344, filed Sep. 20, 2006 and Provisional Application Ser. No. 60/887,085, Filed Jan. 29, 2007, both entitled “Method and Apparatus for Microwave Induced Pyrolysis of Arsenical Ores and Ore Concentrates”, which are both incorporated herein by this reference.

### FIELD OF THE INVENTION

The invention relates generally to the removal of arsenic from arsenical pyrite materials and particularly to the removal of arsenic from arsenical pyrite ores and concentrates containing one or more valuable metals.

### BACKGROUND OF THE INVENTION

Many commercially important transition metals occur naturally in chemical compositions with iron and sulfur, including gold and copper. In the gold industry, in particular, these important natural minerals include pyrite and arsenopyrite, which are chemical compositions of iron and sulfur (and arsenic in the case of arsenopyrite). Conventional methods of recovering the gold from this composition ultimately aim to produce an oxidized product, known as hematite, which is an iron oxide to which the gold adheres and which is amenable to cyanide leaching. Without the oxidation process the gold cannot be released into cyanide solution.

Conventional oxidation techniques include roasting, pressure oxidation and bio-oxidation.

In a standard roaster, pure molecular oxygen is fed to the pyrite-arsenopyrite mixture, which is ignited and burned using the sulfur as a fuel source. In so doing, both the sulfur and arsenic are oxidized into their products sulfur dioxide and arsenic trioxide, respectively. The sulfur dioxide must be scrubbed from the exhaust gases and disposed of. The arsenic trioxide is an extremely toxic substance for which no acceptable end-product or suitable containment system is presently available. Environmental legislation in many parts of the world will not permit the operation of standard roasters.

A modification of the standard roaster, known as the Circulating Fluid Bed (CFB) roaster, utilizes the addition of lime to the arsenopyrite such that the sulfur dioxide is captured to produce a different sulfur compound (calcium sulfate) known as gypsum. The addition of lime further increases the total mass of material to be handled and processed. Arsenic is still oxidized into arsenic trioxide. As such, the CFB roaster offers only a partial solution to the treatment of arsenopyritic ores and does not address the arsenic issue at all.

Fluidized bed reactors are presently widely used in many material processing applications, where a strong interaction between a solid product and gas medium is required, and the use of microwave energy to provide some or all of the required reaction energy has been disclosed in, for example, U.S. Pat. No. 4,967,486 (Doelling) which describes a simple batch processor; U.S. Pat. No. 4,511,362 (Ravindram et al) describes a chlorinolysis process for desulfurization of coal; U.S. Pat. No. 4,476,098 (Nakamori et al) discloses a means of dewatering nuclear fuel using a weir-partitioned reactor chamber; U.S. Pat. No. 5,382,412 (Kim et al) describes a means of preparing polycrystalline silicon using a dual-chamber reactor; U.S. Pat. No. 5,051,456 (Bernier et al) describes a means of removing diene from resins, including the step of adding an absorptive dielectric material to enhance microwave coupling; U.S. Pat. Nos. 4,311,520 and 4,324,582 (Kruesi) describe the formation of soluble metallic oxide products using a small batch process, however this device produces a completely uncontrolled reaction which cannot be scaled for industrial applications; U.S. Pat. No. 5,972,302 (Tranquilla et al) teaches the controlled oxidation of pyritic ores by maintaining the temperature essentially below 520° C.; U.S. Pat. No. 5,824,133 (Tranquilla) discloses a means of treating metallic ores using extremely high-Q resonant applicators with the material flow confined to a thin stream.

Pressure oxidation (autoclaving) is a method for treatment of pyritic and arsenopyritic ores whereby the material to be treated, including lime additive, is taken into an acidic solution at elevated temperature and pressure. Molecular oxygen is introduced to promote oxidation. Sulfur is captured in gypsum and the arsenic forms a compound known as ferric arsenate, which is regarded as a stable product for disposal. Recent research has shown, however, that under some conditions ferric arsenate can reduce in the environment to release soluble arsenic into water. Ferric arsenate will, therefore, require permanent containment storage.

In practical use, both CFB roasters and autoclaves can be extremely expensive to construct and operate.

Bio-oxidation pretreatment utilizes natural bacteria to produce enzymes which in turn are used to oxidize the sulfidic ores. However, this process can be highly sensitive to variables such as temperature, sulfur concentration and the presence of other minerals which may be toxic to the bacteria. Furthermore, the process can be expensive and relatively slow, rendering it commercially unviable in many situations.

### SUMMARY OF THE INVENTION

These and other needs are addressed by the various embodiments and configurations of the present invention. The present invention is directed to removal of arsenic from arsenic-containing sulfidic materials, particularly valuable metal-containing materials, by microwave induced pyrolysis.

In a first embodiment of the present invention, a process is provided that includes the steps:

(a) passing microwave energy through a sulfidic material including arsenopyrite to reduce most, if not all, of the arsenopyrite to arsenic sulfide and form a calcine, the material being positioned in a reaction chamber of a reactor vessel; and

(b) removing the arsenic sulfide from the calcine.

Commonly, the microwave energy heats selectively the mixture of pyritic-arsenopyritic in the material, preferably in the presence of an inert gas such as nitrogen, to initiate and sustain a pyrolysis reaction, which combines the arsenic (from the arsenopyrite) with sulfur (from the pyrite) to produce arsenic sulfide, primarily according to the reaction FeAsS+FeS₂=2FeS+AsS. This process can fix most, if not all, of the arsenic as a stable sulfide compound without the formation of either sulfur dioxide or arsenic trioxide and without the addition of reagents.

In a preferred process configuration, while the sulfidic material is irradiated with microwave energy a gas is passed through the material to remove arsenic sulfide. The gas is substantially free of oxidants, such as molecular oxygen. After removal from the reaction chamber of the reaction vessel, the gas is maintained at a temperature above a condensation temperature of arsenic sulfide while the gas is transported to a condensing vessel. In the condensing vessel, most, if not all, of the arsenic sulfide is removed from the gas. Typically, the gas, before contact with the condensing vessel includes at least about 20 mole % arsenic sulfide vapor and, after discharge from the condensing vessel, has no more than about 0.1 mole % arsenic sulfide vapor.

The microwave energy source comprising one or more individual generating units generating the microwave energy preferably has a power level in the range of about 1 kw to about 150 kw per generating unit and operates at a frequency ranging from about 300 MHz to about 30 GHz.

The reactor vessel preferably has an unloaded Q value ranging from about 1,000 to about 25,000, and the microwave energy delivered to the arsenic-containing material preferably ranges from about 250 to about 300,000 Joules/gm. Most, if not all, of the microwave energy has a frequency of about 915 MHz.

To inhibit pyrite combustion, after removal of the calcine from the reactor vessel the calcine is typically maintained in an atmosphere substantially free of oxidants until the calcine is cooled to a temperature of less than about 350° C.

The process of the present invention can continuously and controllably pyrolyze a mixture of arsenopyrite and pyrite, to remove the arsenic as a stable arsenic sulfide compound substantially without the formation of arsenic trioxide and sulfur dioxide.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Arsenic sulfide” refers to any arsenic compound containing only arsenic and sulfur, including, without limitation, alacranite (AsS), orpiment (As₂S₃), dimorphite (As₄S₃) and realgar (As₄S₄).

“Sulfidic” refers to materials containing sulfide sulfur. The sulfide sulfur can be present as many types of compounds or minerals, including marcasite, pyrrhotite, chalcopyrite, arsenopyrite, bornite, chalcocite, covellite, galena, molybdenite, sphalerite, and tetrahedrite, to name but a few.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is a cross-sectional view of a fluidized bed reactor according to an embodiment of the invention; and

FIG. 2 is a block diagram of an experimental set up according to an embodiment of the invention.

### DETAILED DESCRIPTION

In certain embodiments, the present invention relies on pyrolysis of arsenopyrite to form iron and arsenic sulfides. The pyrolysis reaction involves the combination of arsenopyrite and pyrite to produce arsenic sulfide and pyrrhotite according to:
FeAsS+FeS₂=2FeS+AsS (1)
FeS₂=FeS+0.5 S₂ (2)

In fact, pyrrhotite can exist in the general form Fe₁₋ₓS; in this case the predominant form is Fe_{0.877}S, resulting in the reaction equations
FeAsS+1.326 FeS₂=2.653 Fe_{0.877}S+AsS (3)
2.326 FeS₂=2.653 Fe_{0.877}S+S₂ (4)

The first and third reactions (1) and (3) are endothermic and produce arsenic sulfide in a fume (vapor) state above approximately 550° C. When operated above 600° C. the process is very rapid. The second and fourth reactions (2) and (4), pyrite conversion into pyrrhotite and sulfur, are also endothermic and occur above approximately 620° C. The only requirement for complete arsenic reaction is the availability of sufficient sulfur (here in the form of pyrite) to form the equimolar AsS product.

It is important that these reactions (1)-(4) be run in the absence or substantial absence of molecular oxygen and other oxidants, since both of the pyritic reagents are highly reactive to oxygen and will form As₂O₃ and SO₂. Any oxidant-free inert atmosphere may be used (e.g. nitrogen). Once produced, the arsenic sulfide must be (continuously) removed from the reaction environment and contained, usually by means of precipitation through cooling. Precipitation may be by means of water spray or dry cooling.

Because the pyrrhotite stoichiometry may vary, a range of arsenic sulphides may be produced including alacranite (AsS), orpiment (As₂S₃), dimorphite (As₄S₃) and realgar (As₄S₄).

The ability to maintain the necessary operating conditions for this reaction (equations 3, 4) requires separate control of: (1) an oxygen-free environment for the reactions; (2) the energy introduced into the material; and (3) the gas flow through the reaction environment (coolant). Control of these factors can be achieved using a fluidized bed reactor with energy supplied by microwave energy.

Embodiments of the present invention disclose a system by which microwave energy is used to initiate and sustain the reactions described above. Microwave energy is particularly attractive because it heats selectively certain components of the material more than others and because the amount and rate of energy delivered into the material is independent of the chemical reactions. For most sulfidic materials, the gangue is weaky microwave absorptive, microwave reflective, or substantially transparent to microwave radiation while sulfide minerals containing certain metals or arsenic are highly absorbent of microwave energy.

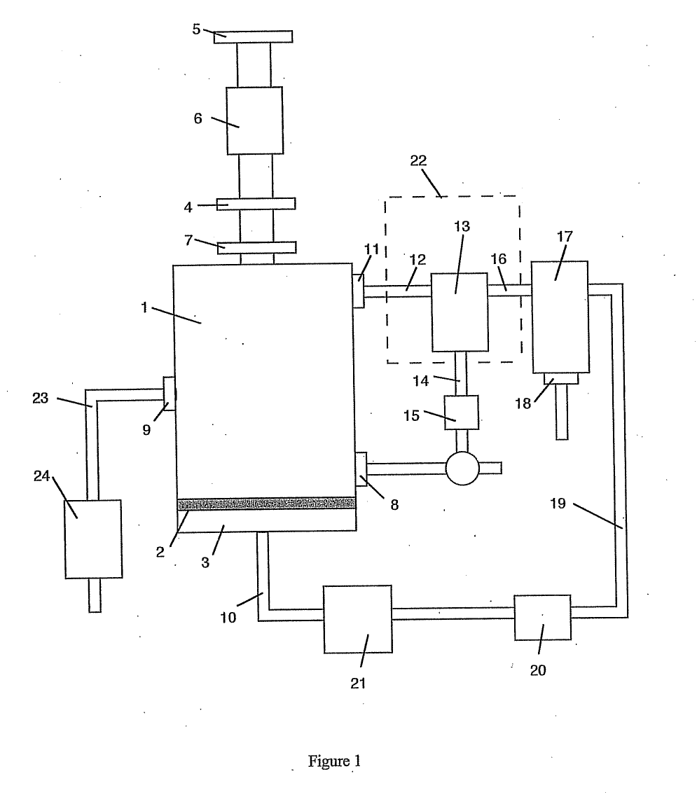

In the embodiment of the invention as illustrated in FIG. 1, there is provided a reaction vessel, such as a fluidized bed reactor, which comprises a reactor chamber or cavity 1, a bed fluidizer screen 2 and a pressure chamber 3. The reactor chamber is connected to a microwave energy source via waveguide fittings 4 and 5 and a tuning device 6 as well as a pressurized gas seal 7. The reactor chamber 1 has a material inlet valve 8, material exit valve 9, gas inlet valve 10 and gas exhaust port 11. Exhaust port 11 is connected to pipe 12 which is in turn connected to a particulate separator 13 (which may be a cyclonic separator). Material collected in the particulate separator may flow through pipe 14 and valve 15 to join the material inlet valve 8 (as shown) or alternatively may join the material exit valve 9, depending upon whether the particulate material has been suitably depleted of its arsenic component.

The microwave containment walls of the reaction vessel and chamber are preferably constructed of a microwave reflective material. The reaction vessel may optionally include an inner vessel which is constructed of essentially microwave-transparent material. Examples of suitable materials include alumina, aluminum silicate, quartz, and low-metal ceramics (which are substantially transparent to microwave energy) and stainless steel, mild steel, nickel alloys, and aluminum alloys (which are reflective of microwave energy).

The arsenic-containing material is introduced into the reactor vessel through the material inlet valve (8), by a screw feeder. The rate at which material is fed into the reactor is determined by the speed of the screw feeder. Typically, the arsenic-containing material is fed into the vessel at a rate sufficient to provide a desired average residence time of the material in the reactor cavity.

The arsenic-containing material has a variety of components. Typically, the material comprises at least about 20 wt. % sulfide sulfur and more typically from about 30 to about 40 wt. % sulfide sulfur, at least about 0.1 ounce/ton and more typically from about 0.5 to about 5 ounce/ton selected valuable metal, and at least about 2 wt. % and more typically from about 5 to about 12 wt. % arsenic, with the remainder being one or more of silicates, carbonates, and other compounds. The selected valuable metal is typically a transition metal, with precious and base metals being more typical. The material may be in the form of an ore, concentrate, tailings, or combinations thereof.

Because water is strongly absorptive of microwave energy, it is preferred that the material be substantially dried before processing the reactor cavity. This is preferably done by heating the material at low temperature and/or exposing the material to sunlight for a prolonged period. Preferably, the water content of the material is no more than about 10 wt. % and even more preferably no more than about 1 wt. %. Excess water in the material can increase microwave energy requirements.

The arsenic-containing material to be processed is finely ground before introduction into the reaction vessel. Preferably, the material is comminuted to a P₈₀ size preferably ranging from about 200 mesh to about 400 mesh and introduced through the material inlet valve (8) at a material flow rate which results in an average residence time inside the reaction chamber of from about 1 minute to about 10 minutes.

To control soluble arsenic oxide formation, the reduction of arsenopyrite is preferably performed in an oxidant-free atmosphere. More preferably, the gaseous atmosphere in the cavity 1 includes no more than about 0.1 mole % oxidants, such as molecular oxygen. To make this possible, the fluidizing gas, prior to contact with the fluidized bed, preferably includes no more than about 0.1 mole % oxidants. The fluidizing gas can include reductants, such as carbon monoxide or molecular hydrogen, but is preferably composed primarily of an inert gas, such as molecular nitrogen. More preferably, the fluidizing gas, before introduction with the fluidized bed, comprises at least about 90 mole % molecular nitrogen and even more preferably at least about 99 mole % molecular nitrogen.

The fluidizing velocity of the gas is preferably sufficient to suspend the material in the bed and provide a selected residence time of the material in the bed. Preferably, the velocity of the fluidizing gas ranges from about the minimum fluidization velocity of the largest ore particle size to about the terminal velocity of the smallest ore particle size.

While the material is fluidized in the bed, it is irradiated with microwave energy. The microwave energy is absorbed by the arsenic-containing sulfides, particularly arsenopyrite, and possibly other metal sulfides, thereby rapidly heating the bed. The heating mechanism results from a combination of dielectric and ohmic heating, whereby both electrical displacement and conduction currents are used to convert the electromagnetic energy directly into heat within the material. The efficiency of this energy conversion is dependent upon the dielectric properties of the material to be treated. Microwave receptor elements, principally arsenopyrite and possibly other metal sulfides, are rapidly heated in a controlled manner.

Temperature, heating rate, and/or microwave coupling can be controlled in a number of ways. As will be appreciated, dielectric loss factors of the material constituents can be temperature dependent. Accordingly, it is desirable to optimize dynamically the coupling between the magnetron or other microwave generating source and the cavity and the resonant tuning of the cavity. The degree of coupling or matching of the cavity with the magnetron determines the efficiency with which energy is delivered to the cavity. Preferred coupling is as close to unity as possible. In one approach, the power of the microwaves and the time of application of the microwaves are controlled. In another approach, the power of the microwaves is adjusted according to the heating temperature. In yet another approach, an aperture size of a variable iris and/or the tuner device positioned in the waveguide is adjusted in response to the temperature of the bed and/or the power of the reflected microwaves (relative to the microwaves entering the reactor). Coupling is optimized as reflected energy is minimized.

Preferably, the microwave source comprising one or more generating units generates power levels in the range of about 1 kw to about 150 kw per generating unit. The specific energy delivered to the bed in the cavity ranges from about 250 to about 300,000 Joules/gm or from about 2 to about 20 kW-h/t. The unloaded Q factor in the cavity preferably ranges from about 1,000 to about 25,000, but most preferably is at least about 200,000. The frequency of the microwave source preferably ranges from about 300 MHz to about 30 GHz, with preferred microwave frequencies being within the Industrial, Scientific, and Medical (ISM) bands of about 915 MHz and about 2,450 MHz, with the ISM band of about 915 MHz being particularly preferred.

Process control is normally affected using a variety of instrumentation positioned in the waveguides and reactor cavity. For example, temperature probes are installed at various positions within the fluidized bed and all feed and discharge lines, including the gas inlet and outlet lines. Gas pressure and product monitors are installed in all gas lines. Material flow through the reactor cavity is measured either through flow meters or by mass measurements. A microwave reflection detector is positioned in the waveguide.

Gaseous products passing, via the exhaust port 11, through particulate separator 13 include the fluidizing gas, preferably molecular nitrogen gas, as well as arsenic sulfide vapor from the reaction within the reaction chamber 1. The gaseous products passing through the particulate separator 13 pass through pipe 16, which is connected to a condensing vessel 17. In the condensing vessel 17, the gaseous products are cooled either through radiative cooling or contact with a coolant water spray, which is introduced into the condensing vessel 17. In this manner, the temperature of the arsenic sulfide fume is reduced below its condensation point, and arsenic sulfide is precipitated from the gas stream. Arsenic sulfide precipitate, so formed, is collected at the bottom of the condensing vessel 17 and removed via valve 18 for containment and disposal.

Typically, most, and even more typically at least about 99%, of the vapor phase arsenic sulfide is removed from the fluidizing gas. Before contact with the condensing vessel 17, the fluidizing gas commonly comprises from about 15 to about 30 mole % arsenic sulfide vapor and, after contact with the condensing vessel 17, no more than about 0.1 mole % arsenic sulfide vapor.

Cooled gaseous products essentially cleaned of arsenic sulfide fume are passed through pipe 19 to a moisture trap 20, which is further connected to the fluidizing blower or fan 21 by which means the closed gas recycle circuit is thus completed via pipe 10.

Reduced solid material or calcine exiting from valve 9 passes through pipe 23 into a cooling chamber 24, which may be a water-cooled tank or slurry tank, to reduce the temperature of the discharged calcine below the combustion point of pyrite in air. The combustion point is approximately 350° C. Until the calcine temperature is less than the combustion point of pyrite, the calcine is preferably maintained in an atmosphere substantially free of oxidants to avoid pyrite combustion. Thus, the atmospheres in the water-cooled tank or slurry, valve 9, and pipe 23 are substantially free of oxidants.

The reduced solid material, or calcine, preferably is substantially free of arsenic and arsenic oxides. Commonly, at least most and even more commonly at least about 90% of the arsenic in the arsenic-containing material, before reduction, is converted into arsenic sulfide vapor and removed from the material. Stated another way, the reduced material or calcine, after removal from the cavity 1, typically contains no more than about 0.5 and even more typically no more than about 0.1 wt. % arsenic and no more than about 0.05 wt. % arsenic oxides.

An important aspect of the operation of this embodiment is the provision of a system to maintain the temperature of the gaseous products within pipes 12, 16 and 14 as well as within the particulate separator 13 and valve 15 above the evaporation temperature of arsenic sulfide. The condensation or evaporation temperature of arsenic sulfide is approximately 350° C. Condensation of arsenic sulfide in any of these locations could create numerous problems, including constriction of the orifice through which the gas flows. Such constrictions would create a back pressure that is detrimental to bed fluidization. Maintaining the temperature in these locations above the condensation point of arsenic sulfide may be accomplished, for example, using an electrically heated tape 22, which is closely wrapped around said components and which is thermostatically controlled to maintain said minimum temperature. Alternatively, passive insulation may be employed to impede heat dissipation. By such active and/or passive means, the arsenic sulfide is prevented from condensing within said components and blocking the gas flow.

Treatment of a pyritic-arsenopyritic-containing material, according to the present invention, is described as follows:

The pyritic-arsenopyritic material is loaded into a reaction chamber, where the material is heated by microwave energy in the presence of an inert atmosphere, such as nitrogen. The microwave energy raises the temperature of the material to the preferred operating temperature in the range of from about 450° C. to about 750° C. and even more preferably from about 500° C. to about 650° C., at which temperature the reaction takes place approximately as FeAsS+FeS₂=2FeS+AsS or more specifically as (eq. 3). This reaction is endothermic and the microwave energy is thus required to sustain the reaction temperature and to compensate for thermal losses.

The treatment process is operated preferably in a continuous manner and the material flow rate through the reactor vessel is controlled such that the ore being discharged is depleted of arsenic to the desired extent, the material so discharged being continuously monitored for arsenic content.

In a batch operation, completion of sulfide sulfur reduction can be indicated by a substantial drop in bed temperature, even though microwave energy is still being passed through the bed. This is so because the microwave absorptivities of the gangue components of the material (or most of the material constituents) are commonly substantially less than that of the arsenic sulfides. Typically, the reduced material is removed from the cavity when the bed temperature decreases, even more typically when the bed temperature decreases by at least about 50° C. and even more typically by at least about 100° C.

Preferably, the residence time of the material in the reactor cavity preferably is no more than about 10 minutes and even more preferably ranges from about 1 to about 5 minutes, though the precise residence time depends on the power of the microwave source and the nature of the gangue associated with the selected metal sulfide.

The valuable metal content of the calcine, most of which remains in the calcine, can then be recovered by known techniques, including acidic (e.g., with a mineral acid) or alkaline (e.g., with cyanide) leaching followed by isolation of the dissolved valuable metal from the pregnant leach solution. Isolation can be realized by many methods, including precipitation, cementation, sorption onto an organic media followed by desorption, electrowinning, and the like.

The process embodied in the present invention is further illustrated by the following examples:

### Experimental

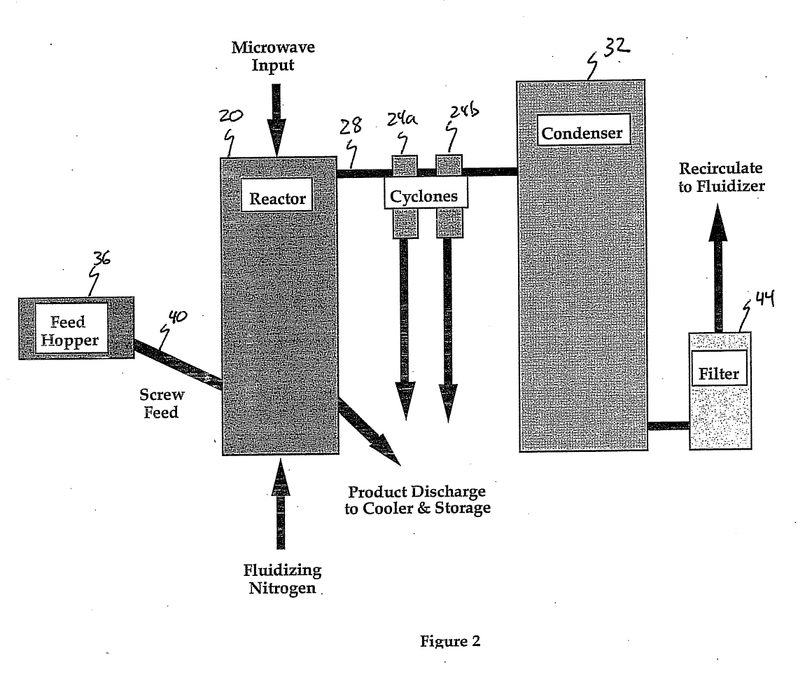

Several experiments have been carried out to demonstrate the effectiveness of the disclosed process. The experimental setup is shown in FIG. 2 and includes a fluid bed reactor 20, one or more cyclone separators 24a-b in the gas discharge line 28 and a fume condenser/filter assembly 32. Microwave energy is supplied to the reactor vessel 20. Mineral feedstock is ground to the particle size distribution shown in Table 1 and is fed continuously from the hopper 36 into the reactor 20 by means of a screw feed assembly 40. Mineral feedstock comprised dominant pyrite and arsenopyrite as:

Fe 33.9%

As 7.7% as arsenopyrite

S 33.0% as sulfide

Gangue 21.4%

The material is fluidized inside the reactor 20 by means of a nitrogen gas feed and is continuously discharged by means of an overflow valve. Some of the fine particles of ore material, as well as the arsenic sulfide fume generated in the reaction, are carried by the hot discharge gas and are separated from the gas stream by means of the cyclone separators 24a-b. The fume is carried into the condenser vessel 32, where the gas stream is cooled below the condensation temperature of the fume; the fume condenses and precipitates to the bottom of the vessel 32, and the cooled gas is further filtered by filter 44 of any remaining particulate and vented to atmosphere or reused as fluidizing gas.

TABLE 1
Wet Vibrating Sieve Particle Size Analysis

| Mesh | Micron | Cumulative Passing | Individual Retained |
|---|---|---|---|
| 50 | 300 | 100.00% | 0.00% |
| 100 | 150 | 78.50% | 21.50% |
| 140 | 106 | 67.74% | 10.76% |
| 200 | 75 | 55.72% | 12.02% |
| 325 | 45 | 34.68% | 21.04% |
| 400 | 38 | 27.18% | 7.50% |
| 450 | 32 | 24.36% | 2.82% |
| 500 | 25 | 18.86% | 5.50% |
| 635 | 20 | 15.91% | 2.95% |
| Pan | <20 | 0.00% | 15.91% |

### EXAMPLE 1

The reactor was initially charged with a 50:50 mix (40 lb total) consisting of raw concentrate and Pyrrhotite (from previous pyrolysis). Extensive batch testing had demonstrated that a full startup charge of raw concentrate would produce a large, rapid discharge of AsS as the temperature reached pyrolysis (about 550° C.). This AsS discharge tends to plug the piping at the cyclone(s), particularly if the pipes are not maintained above pyrolysis temperature.

The reactor charge was initially heated by microwave power as a batch load; when the temperature reached approximately 500° C. the material feed was commenced and thereafter the reactor operated in a continuous-feed mode. At shutdown, the microwave energy was stopped, the feed screw was stopped, and the fluidization was continued until the charge cooled below pyrolysis temperature. Material left in the reactor (labeled “Reactor Calcine”) as well as at all collection points was measured for mass balance.

Target operating temperature was 550° C. with feed rates of 0.5-1.0 lb/minute. Only the arsenic pyrolysis reaction was intended.

| Initial charge: | 40 lb (50:50 mix of Raw concentrate and Pyrrhotite) | |
|---|---|---|
| Material feed: | 34.75 lb | |
| Total material: | 74.75 lb | |
| Test duration: | 230 minutes (from start) | |
| Test duration: | 160 minutes (from initial pyrolysis) | |
| Samples collected: | Calcine @ T202 | 0.50 lb |
| | Cyclone @ T202 | 0.60 lb |
| | Calcine barrel | 15.5 lb |
| | Cyclone barrels | 12.25 lb |
| | Reactor calcine | 22.45 lb |
| | Reactor clinker | 8.45 lb |
| | Condenser (yellow) | 5.65 lb |
| | Cyclone chunks | 0.70 lb |
| Total material | 66.13 lb | |
| accounted | | |
| Unaccounted | 8.62 lb | |

Unaccounted material was lost to the gas discharge from the condenser. By chemical and spectrographic analysis the arsenic and sulfur concentrations in the various feed and output streams are shown in Table 2.

TABLE 2
Arsenic and Sulfur Concentration

| | Concentration % | | | | |
|---|---|---|---|---|---|
| | Raw | | Product | Reactor | |
| Element | Concentrate | 50:50 Starter | Calcine | Calcine | Condenser |
| As | 9.41 | 5.66 | 0.40-1.69 | 0.49 | 55.73 |
| S | 26.08 | 24.27 | 25.65 | 20.35 | 22.58 |

Based on the process reaction, the predicted sulfur concentration in the product calcine is 26.1% by weight.

It is evident from this example that the arsenic concentration has been greatly reduced (within approximately 98.5% of the theoretical valve) through the formation and removal of arsenic sulfide as a yellow precipitated powder.

### EXAMPLE 2

The reactor was initially charged with a 50:50 mix (40 lb total) consisting of raw concentrate and Pyrrhotite (from previous pyrolysis).

The reactor charge was initially heated by microwave power as a batch load; when the temperature reached approximately 500° C. the material feed was commenced and thereafter the reactor operated in a continuous-feed mode. At shutdown the microwave energy was stopped, the feed screw was stopped and the fluidization was continued until the charge cooled below pyrolysis temperature. Material left in the reactor (labeled “Reactor Calcine”) as well as at all collection points was measured for mass balance.

Target operating temperature was 550° C. with feed rates of 0.5-1.0 lb/minute. Only the arsenic pyrolysis reaction was intended.

| Initial charge: | 40 lb (50:50 mix of Raw concentrate and Pyrrhotite) | |
|---|---|---|
| Material feed: | 103.95 lb | |
| Total material: | 143.95 lb | |
| Test duration: | 240 minutes (from start) | |
| Test duration: | 180 minutes (from initial pyrolysis) | |
| Samples collected: | Calcine @ T118 | 0.55 lb |
| | Cyclone @ T118 | 1.00 lb |
| | Calcine @ T213 | 0.90 lb |
| | Cyclone @ T213 | 2.75 lb |
| | Top Calcine barrel | 1.20 lb |
| | Calcine barrel | 47 00 lb |
| | Cyclone barrels | 41.20 lb |
| | Reactor calcine | 16.15 lb |
| | Reactor clinker | 13.40 lb |
| | Condenser (green) | 20.65 lb |
| | Cyclone chunks | 0.35 lb |
| Total material | 145.15 lb | |
| accounted | | |
| Unaccounted | (1.20) lb | |

Unaccounted material was lost to the gas discharge from the condenser. By chemical and spectrographic analysis the arsenic and sulfur concentrations in the various feed and output streams are shown in Table 3.

TABLE 3
Arsenic and Sulfur Concentration

| | Concentration % | | | | |
|---|---|---|---|---|---|
| | Raw | 50:50 | Product | Reactor | |
| Element | Concentrate | Starter | Calcine | Calcine | Condenser |
| As | 9.41 | 5.66 | 0.95-1.00 | 1.62 | 45.39 |
| S | 26.08 | 24.27 | 23.21 | 18.23 | 22.79 |

Based on the process reaction, the predicted sulfur concentration in the product calcine is 26.1% by weight.

It is evident from this example that the arsenic concentration has been greatly reduced (within approximately 88.9% of the theoretical valve) through the formation and removal of arsenic sulfide as a yellow precipitated powder.

### EXAMPLE 3

The reactor was initially charged with a 50:50 mix (40 lb total) consisting of raw concentrate and Silica flour.

The reactor charge was initially heated by microwave power as a batch load; when the temperature reached approximately 500° C. the material feed was commenced and thereafter the reactor operated in a continuous-feed mode. At shutdown the microwave energy was stopped, the feed screw was stopped, and the fluidization was continued until the charge cooled below pyrolysis temperature. Material left in the reactor (labeled “Reactor Calcine”) as well as at all collection points was measured for mass balance.

Target operating temperature was 600° C. with feed rates of 0.5-2.0 lb/minute. Only the arsenic pyrolysis reaction was intended.

| Initial charge: | 40 lb (50:50 mix of Raw concentrate and Silica Flour) | |
|---|---|---|
| Material feed: | 176.65 lb | |
| Total material: | 216.65 lb | |
| Test duration: | 300 minutes (from start) | |
| Test duration: | 220 minutes (from initial pyrolysis) | |
| Samples | Calcine @ T206 | 0.40 lb |
| collected: | Cyclone @ T206 | 0.60 lb |
| | Calcine @ T254 | 1.10 lb |
| | Cyclone @ T254 | 0.55 lb |
| | Calcine @ T290 | 1.20 lb |
| | Cyclone @ T290 | 1.20 lb |
| | Calcine barrel | 103.10 lb |
| | Cyclone barrels | 41.40 lb |
| | Reactor calcine | 28.60 lb |
| | Reactor clinker | 0.00 lb |
| | Condenser | 19.35 lb |
| | Cyclone chunks | 1.10 lb |
| Total material | 198.60 lb | |
| accounted | | |
| Unaccounted | 18.05 lb | |

Unaccounted material was lost to the gas discharge from the condenser. By chemical and spectrographic analysis the arsenic and sulfur concentrations in the various feed and output streams are shown in Table 4.

TABLE 4
Arsenic and Sulfur Concentration

| | Concentration % | | | | |
|---|---|---|---|---|---|
| | Raw | 50:50 | Product | Reactor | |
| Element | Concentrate | Starter | Calcine | Calcine | Condenser |
| As | 8.58 | — | 1.40 | 0.64 | 62.36 |
| S | 24.50 | — | 18.50 | 16.90 | 21.10 |

Based on the process reaction, the predicted sulfur concentration in the product calcine is 24.7% by weight.

It is evident from this example that the arsenic concentration has been greatly reduced (within approximately 74.9% of the theoretical valve) through the formation and removal of arsenic sulfide as a yellow precipitated powder.

By observation of these experimental data, notwithstanding the fact that the metal extraction process has not been optimized with respect to various possible performance measures, it is evident that the microwave process is effective in greatly reducing the arsenic content of arsenopyritic ore without the formation of arsenic trioxide. It is also evident that the microwave process is effective in reducing the sulfur content of the associated pyritic ore, to the extent needed to form the arsenic sulfide product. By such means, the reduced sulfur content lessens the sulfur dioxide production in subsequent processing stages.

It is also evident that the microwave process is effective at all values of arsenic content and that the extent of arsenic depletion is limited only by the available sulfur.

A number of variations and modifications of the invention can be used. It would be possible to provide for some features of the invention without providing others. The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations, combinations, and modifications are within the scope of the invention, e.g., as maybe within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
(a) passing microwave energy through a sulfidic material comprising arsenopyrite to reduce at least most of the arsenopyrite to arsenic sulfide and form a calcine, the material being positioned in a reaction chamber of a reactor vessel; and
(b) removing the arsenic sulfide from the calcine.

2. The method of claim 1, wherein step (b) comprises the sub-steps:
(B1) while the sulfidic material is irradiated with microwave energy, passing a gas through the material to remove arsenic sulfide, the gas being substantially free of oxidants; and
(B2) maintaining the gas, after the passing step (B1) at a temperature above a condensation temperature of arsenic sulfide; and
(B3) while the maintaining step (B2) is performed, transporting the gas to a condensing vessel; and
(B4) thereafter removing, in the condensing vessel, at least most of the arsenic sulfide from the gas.

3. The method of claim 1, wherein a temperature of the sulfidic material during step (a) is at a temperature ranging from about 450° C. to about 700° C., wherein a microwave energy source comprising one or more generating units generating the microwave energy has a power level in the range of about 1 kw to about 150 kw per generating unit, operates at a frequency ranging from about 300 MHz to about 30 GHz, wherein the reactor vessel has a Q value ranging from about 1,000 to about 25,000, wherein the microwave energy delivered to the arsenic-containing material ranges from about 250 to about 300,000 Joules/gm, and wherein at least most of the microwave energy has a frequency of about 915 MHz.

4. The method of claim 1, wherein a temperature of the sulfidic material during step (a) is at a temperature of no more than about 690° C. and wherein the calcine comprises no more than about 0.01 wt. % arsenic oxides.

5. The method of claim 2, wherein, in step (B1), the gas fluidizes and suspends a bed of the sulfidic material, wherein the gas has a velocity ranging from about the minimum fluidization velocity of the largest ore particle size to about the terminal fluidization velocity of the smallest ore particle size and wherein the gas, before passing though the material, comprises no more than about 0.01 mole % oxidants.

6. The method of claim 2, wherein the gas, before contact with the condensing vessel comprises at least about 10 mole % arsenic sulfide vapor and wherein the gas, after discharge from the condensing vessel, comprises no more than about 0.1 mole % arsenic sulfide vapor.

7. The method of claim 1, wherein, after removal of the calcine from the reactor vessel, the calcine is maintained in an atmosphere substantially free of oxidants until the calcine is cooled to a temperature of less than about 350° C.

8. The method of claim 1, wherein at least about 90% of the arsenic in the arsenic-containing material, before reduction, is converted into arsenic sulfide vapor and removed from the material in step (b) and wherein the calcine, after removal from the reactor vessel, contains no more than about 0.5 wt. % arsenic and no more than about 0.01 wt. % arsenic oxides.

9. The method of claim 1, wherein a residence time of the arsenic-containing material in the reactor vessel is no more than about 10 minutes.

10. Calcine produced by the method of claim 1.

11. A process, comprising:
(a) passing microwave energy through a sulfidic material comprising arsenopyrite and pyrite to reduce at least most of the arsenopyrite to arsenic sulfide and form a calcine, the material being positioned in a reaction chamber of a reactor vessel; and
(b) while the sulfidic material is irradiated with microwave energy, passing a gas through the material to remove arsenic sulfide, the gas being substantially free of oxidants; and
(c) maintaining the gas, after the passing step (b) at a temperature above a condensation temperature of arsenic sulfide; and
(d) while the maintaining step (c) is performed, transporting the gas to a condensing vessel; and
(e) thereafter removing, in the condensing vessel, at least most of the arsenic sulfide from the gas.

12. The process of claim 11, wherein a temperature of the sulfidic material during step (a) is at a temperature ranging from about 450° C. to about 700° C., wherein a microwave energy source comprising one or more individual generating units generating the microwave energy has a power level in the range of about 1 kw to about 150 kw per generating unit, operates at a frequency ranging from about 300 MHz to about 30 GHz, wherein the reactor vessel has an unloaded Q value ranging from about 1,000 to about 25,000, wherein the microwave energy delivered to the arsenic-containing material ranges from about 250 to about 300,000 Joules/gm, and wherein at least most of the microwave energy has a frequency of about 915 MHz.

13. The process of claim 11, wherein a temperature of the sulfidic material during step (a) is at a temperature of no more than about 690° C. and wherein the calcine comprises no more than about 0.01 wt. % arsenic oxides.

14. The process of claim 11, wherein, in step (b), the gas fluidizes and suspends a bed of the sulfidic material, wherein the gas has a velocity ranging from about the minimum fluidization velocity of the largest material particle size to about the terminal fluidization velocity of the smallest material particle size and wherein the gas, before passing though the material, comprises no more than about 0.01 mole % oxidants.

15. The process of claim 11, wherein the gas, before contact with the condensing vessel comprises at least about 10 mole % arsenic sulfide vapor and wherein the gas, after discharge from the condensing vessel, comprises no more than about 0.1 mole % arsenic sulfide vapor.

16. The process of claim 11, wherein, after removal of the calcine from the reactor vessel, the calcine is maintained in an atmosphere substantially free of oxidants until the calcine is cooled to a temperature of less than about 350° C.

17. The process of claim 11, wherein at least about 90% of the arsenic in the arsenic-containing material, before reduction, is converted into arsenic sulfide vapor and removed from the material in step (b) and wherein the calcine, after removal from the reactor vessel, contains no more than about 0.5 wt. % arsenic and no more than about 0.01 wt. % arsenic oxides.

18. The process of claim 11, wherein a residence time of the arsenic-containing material in the reactor vessel is no more than about 10 minutes.

19. Calcine produced by the process of claim 11.

20. Arsenic sulfide produced by the process of claim 11.
